(19) United States
(12) Patent Application Publication
(10) Pub. No.: US 2005/0128323 A1
(43) Pub. Date: Jun. 16, 2005

(54) Image photographing device and method

(76) Inventor: Kwang-Cheol Choi, Gwacheon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/977,467

(22) Filed: Nov. 1, 2004

(30) Foreign Application Priority Data
Oct. 31, 2003 (KR) 2003-76877

(51) Int. Cl. H04N 5/262

(52) U.S. Cl. 348/239

(57) ABSTRACT

An image photographing device and method for combining images with different focal lengths to an in-focus image are provided. In the image photographing device, at least one lens captures images for focusing on scenes having different distances, and an image combination processor segments each of the images into a predetermined number of blocks, selects an in-focus block between every pair of blocks at the same position in the images, and generates a final combined image using the in-focus blocks.

### PRIORITY

This application claims the benefit under 35 U.S.C. §119(a) of an application entitled “Image Photographing Device and Method” filed in the Korean Intellectual Property Office on Oct. 31, 2003 and assigned Serial No. 2003-76877, the entire contents of which are incorporated herein by reference.

### BACKGROUND OF THE INVENTION

1. Field of the Invention

The present invention relates generally to an image photographing device and method. In particular, the present invention relates to an image photographing device and method for combining images with different focal lengths to an in-focus image in a digital camera used for a portable terminal.

2. Description of the Related Art

A digital camera and a camcorder use an Auto Focus (AF) device to focus on a subject. The AF typically controls the position of a lens by using a motor.

FIG. 1 is a block diagram of an image photographing device in a camera including a conventional AF device.

Referring to FIG. 1, a conventional image photographing device such as a traditional camera or camcorder includes a digital converter 13 for digitizing image data captured by a lens 11 and a Charge Coupled Device (CCD) 12, and a Digital Signal Processor (DSP) 20 for processing the digital image data, for example by video compression. The conventional image photographing device performs the AF function by use of a focus step motor 15. The focus step motor 15 operates according to image information received from a microprocessor 30 through a motor drive Integrated Chip (IC) 16.

Such an AF-enabled camera detects the distance to a subject when a change occurs to an image or a zoom function is performed, and gets the subject in an optimum focus using the focus step motor. To maintain the optimum focal state, the AF-enabled camera operates using one of two methods.

One method is to project ultrasound waves or infra-red rays to the subject, calculate the distance between the camera and the subject using a signal reflected from the subject, and thus get the subject into focus. However, this method has the shortcomings that there is a limit on control of the focus length, the distance calculation is not accurate, and an additional device is needed for the distance calculation.

The other method is to analyze the characteristics of an image received from an image input device like a CCD and focus on the subject based on the analysis result. That is, if the subject is out of focus, it is blurred due to the absence of high frequency components. Based on this idea, a lens is positioned at a place (usually at the center of a camera screen) where many high frequency components exist. The lens position is determined to be the focal position of the lens. This method is widely used for high-precision cameras with an electric motor and a plurality of lenses.

Meanwhile, the motor-using AF function is not viable for small-size cameras because a motor occupies a large space. Hence, small-size cameras adopt a wide-angle lens that brings almost all of a subject into focus from front to back, or sets an iris to be narrow. That is, small-size cameras set a deep depth of field (DOF) value without adjusting the distance. The DOF refers to the range of distances from the camera where acceptably sharp focus can be obtained. A shallow DOF produces a picture less in focus or sharp, whereas a deep DOF produces a picture with more in focus or sharpness. The DOF depends on the opening/closing degree of the iris and lens characteristics. As the iris is open wide, the DOF is shallow. For a subject having the same DOF, when the iris is open to a large diameter, a shutter speed is fast and when the iris is open to a small diameter, the shutter speed is slow. By utilizing the relationship between the opening of the iris and the shutter speed, exposure is regulated. Besides, as the focal length of a lens is long (e.g., telescopic lens), the DOF is shallow and as the focal length is short (e.g., wide-angle lens), the DOF is deep. When a subject is in focus, the DOF is deeper in front than in back.

In general, a camera lens translates a three-dimensional subject with a depth onto a planar film. Therefore, when capturing a standard image having a remote background and a nearby subject, a deep-DOF wide-angle lens is used or an iris is narrowed in order to render both the remote background and the near subject clear. However, the use of the wide-angle lens causes distortions in the image and makes the background look farther away than it really is. Also, the distortions are more serious in nearby objects. Hence, it is difficult to focus on an object within a range of 1 meter. Since a narrow iris reduces exposure, the shutter speed must be decreased, thereby impairing the clearness of the image.

Meanwhile, portable phones including cellular phones and Personal Communications Service (PCS) phones have been developed to support data and moving picture services as well as voice service. Now, portable phones aim to expand their use beyond traditional communication service functions.

To mount a camera onto a portable phone, the AF function is generally sacrificed to thereby prevent structural complexity caused by the mechanical characteristics of complex lenses and motors. The camera-equipped portable phone (hereinafter, referred to as a camera phone) is rapidly being developed. Yet, it has some limitations in improving image quality because though the resolution of an image sensor increases, the AF function is omitted. However, adding the AF function is difficult because it requires a large area in a small-size device like a camera phone. Therefore, there is a need for a method of photographing an image without distortion while bringing a subject in focus from front to back, without using the traditional AF function.

### SUMMARY OF THE INVENTION

An object of the present invention is to substantially solve at least the above problems and/or disadvantages and to provide at least the advantages below. Accordingly, an object of the present invention is to provide an image photographing device and method for presenting a distortion-free, precise image with front to back scenes brought into focus.

Another object of the present invention is to provide an image photographing device and method for joining images with different focal lengths by an image processing technique in a camera phone.

A further object of the present invention is to provide an image photographing device and method for preventing image distortions and achieving a precise focus using a standard lens instead of a wide-angle lens in a camera phone.

Still another object of the present invention is to provide an image photographing device and method for stitching a subject to a different background by replacing an existing background with the new one in an image.

The above objects are achieved by providing an image photographing device and method for combining images with different focal lengths to an in-focus image.

According to an aspect of the present invention, in an image photographing device for combining images with different focal lengths to an in-focus image, at least one lens captures images, for focusing scenes having different distances, and an image combination processor segments each of the images into a predetermined number of blocks, selects an in-focus block between every pair of blocks at the same position in the images, and generates a final combined image using the in-focus blocks.

According to another aspect of the present invention, in an image photographing method for combining images with different focal lengths to an in-focus image, the images are captured at different focal lengths simultaneously, each of the images is segmented into a predetermined number of blocks, in-focus blocks are marked in the images, and images represented by the in-focus blocks are combined into a final combined image.

According to a further aspect of the present invention, in an image photographing method for combining images with different focal lengths to an in-focus image, the images are captured at different focal lengths at different time points; each of the images is segmented into a predetermined number of blocks, in-focus blocks are marked in the images, and images represented by the in-focus blocks are combined into a final combined image.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of an image photographing device having a conventional Auto Focus (AF) device in a camera;

FIG. 2 is a block diagram of an image photographing device in a camera phone according to an embodiment of the present invention;

FIG. 3 is a detailed block diagram of an image combination processor in the image photographing device of the camera phone according to an embodiment of the present invention;

FIG. 4 illustrates an example of blocks segmented from an image according to an embodiment of the present invention;

FIG. 5 illustrates an operation for entering block values in a block matrix according to an embodiment of the present invention;

FIGS. 6A and 6B illustrate images with different focal lengths according to an embodiment of the present invention;

FIGS. 7A and 7B illustrate blocks and an image before filtering according to an embodiment of the present invention;

FIGS. 8A and 8B illustrate blocks and an image after repeated filtering according to an embodiment of the present invention;

FIG. 9 illustrates an operation for overlapping image boundaries according to an embodiment of the present invention;

FIG. 10 illustrates a final combined image produced by image combining according to an embodiment of the embodiment of the present invention;

FIG. 11 is a block diagram of an image photographing device in a camera phone according to another embodiment of the present invention;

FIG. 12 is a detailed block diagram of an image combination processor in the photographing device of the camera phone according to the second embodiment of the present invention;

FIGS. 13A, 13B and 13C illustrate images with different focal lengths according to the second embodiment of the present invention;

FIG. 14 illustrates an image before filtering according to the second embodiment of the present invention;

FIGS. 15A to 15D illustrate images after multi-step filtering according to the second embodiment of the present invention;

FIGS. 16A and 16B illustrate extended blocks and an extended image according to the second embodiment of the present invention;

FIGS. 17A, 17B and 17C illustrate further extended blocks and image according to the second embodiment of the present invention;

FIG. 18 illustrates stitching of a final block matrix into a background image according to the second embodiment of the present invention;

FIG. 19 illustrates a final combined image with two images overlapped at their boundaries according to the second embodiment of the present invention; and

FIG. 20 illustrates a final combined image with a different background according to an embodiment of the present invention.

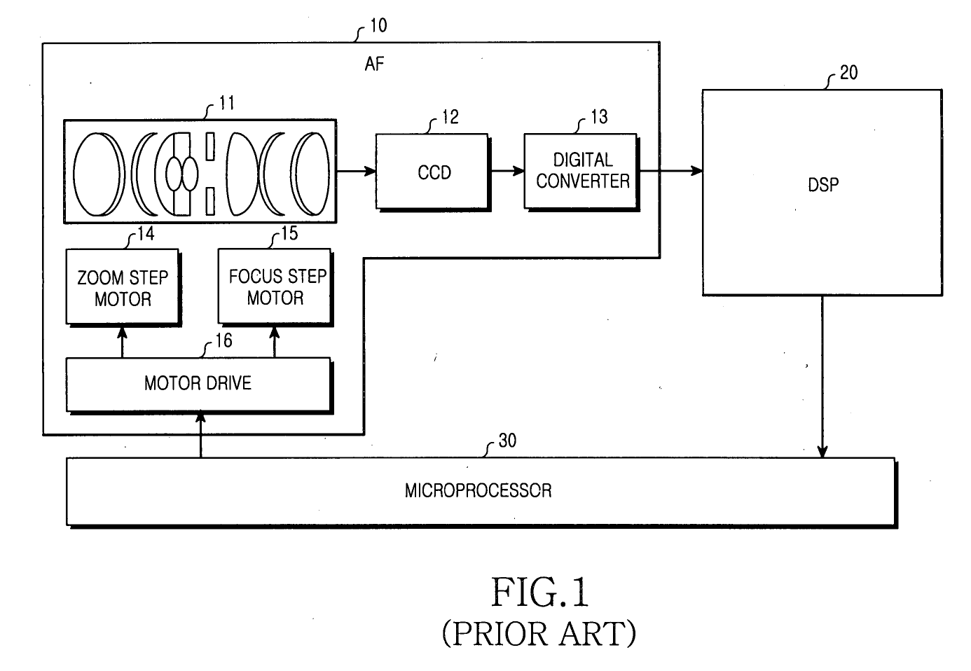

### DETAILED DESCRIPTION OF THE PREFERRED EMBODIMENTS

Embodiments of the present invention will now be described herein below with reference to the accompanying drawings. In the following description, well-known functions or constructions are not described in detail for conciseness.

The present invention provides a method of achieving the effect of bringing both short-distance and long-distance scenes into focus without distortions using a plurality of images for the short-distance and long-distance scenes that are captured without the Auto Focus (AF) feature.

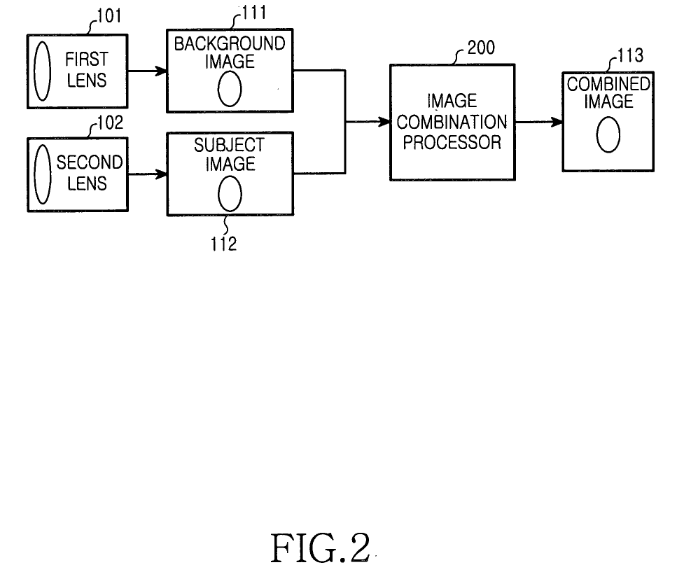

FIG. 2 is a block diagram of an image photographing device in a camera according to an embodiment of the present invention.

Referring to FIG. 2, the image photographing device, which does not have the AF function, is provided with a first lens 101 for capturing an image with a remote background in focus (hereinafter, referred to as a background image 111), a second lens 102 for capturing the image with a nearby subject in focus (hereinafter, referred to as a subject image 112), and an image combination processor 200 for combining the two images captured at different focal lengths.

The image photographing device captures the background image 111 and the subject image 112 at the same time through the first and second lenses 101 and 102 and stores them. The image combination processor 200 joins the images 111 and 112 into a final combined image 113, bringing them into focus. The focal positions of the first and second lenses 101 and 102, a focal length, and the opening of an iris must be set initially. Since deep depth of field (DOF) varies with iris size, shot distance, and focal length, the values must be appropriately set according to an optimum DOF. The structure of the image combination processor 200 will be described below in detail.

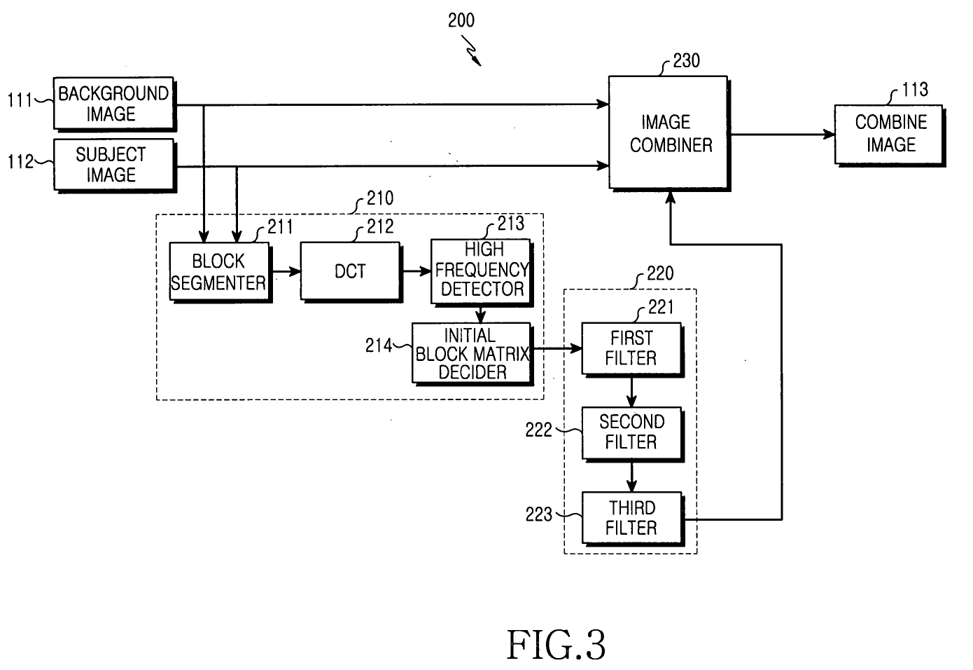

FIG. 3 is a detailed block diagram of the image combination processor in the camera phone according to an embodiment of the present invention.

Referring to FIG. 3, the image combination processor 200 comprises a block matrix unit 210 for detecting high frequency components and generating an initial block matrix, a filter unit 220 for generating a final block matrix by filtering a predetermined block value in the initial block matrix, and an image combiner 230 for stitching the final block matrix into the background image 111.

The block matrix unit 210 includes a block segmenter 211 for segmenting the background image 111 and the subject image 112 into blocks, a Discrete Cosine Transformer (DCT) 212 for representing the blocks in the frequency domain, a high frequency detector 213 for detecting high frequency components from the frequency-domain blocks, and an initial block matrix decider 214 for generating an initial block matrix using the high frequency components.

The filter unit 220 includes a plurality of filters 221, 222 and 223. It filters the initial block matrix in a plurality of steps and outputs a final block matrix representing a subject image approximate to the subject in the subject image 112.

The image combiner 230 combines the final block matrix (i.e. the subject image 112) with the background image 111, overlapping them at their boundaries in order to secure image continuity between them.

Now, a description will be made of an image photographing method for generating a totally clear final combined image using two images with different focal lengths in the thus-configured image photographing device.

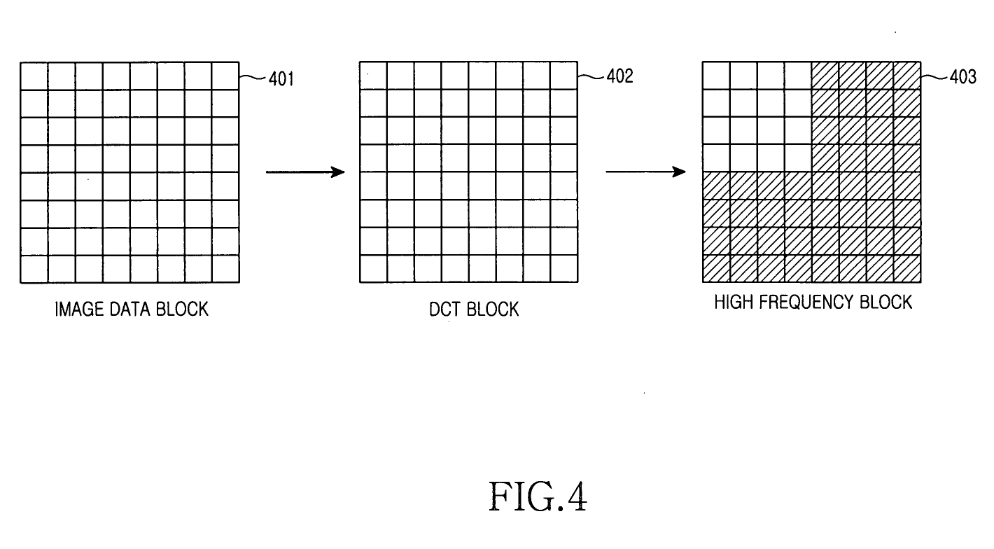

In operation, the image photographing device captures the background image 111 and the subject image 112 through the first lens 101 focusing on a long distance and the second lens 102 focusing on a short distance. The block matrix unit 210 segments the images 111 and 112 into blocks and converts the blocks into frequency components. The DCT conversion is illustrated in FIG. 4.

Referring to FIG. 4, reference numeral 401 denotes an image data block output from the block segmenter 211, for the input of the images 111 and 112. The size of the image data block 401 can be set to any size, but is usually 8×8 or 16×16 pixels. Image data blocks 401 at the same position in the two images 111 and 112 are compared and the one in focus is selected. To do so, a simulation is performed to select an image data block having more high frequency components. Or any other method can also be used.

The image data blocks 401 are converted to frequency components, that is, DCT blocks 402 in the DCT 212. Then, high frequency blocks are detected in the DCT blocks in the high frequency detector 213. For 8×8 high frequency blocks, the frequency components of each of high frequency blocks in the two images 111 and 112 are summed vertically and horizontally and a high frequency block having the most high frequency components is selected as an in-focus block. The DCT 212 can be implemented by using an existing DCT mounted for video compression, without being procured separately.

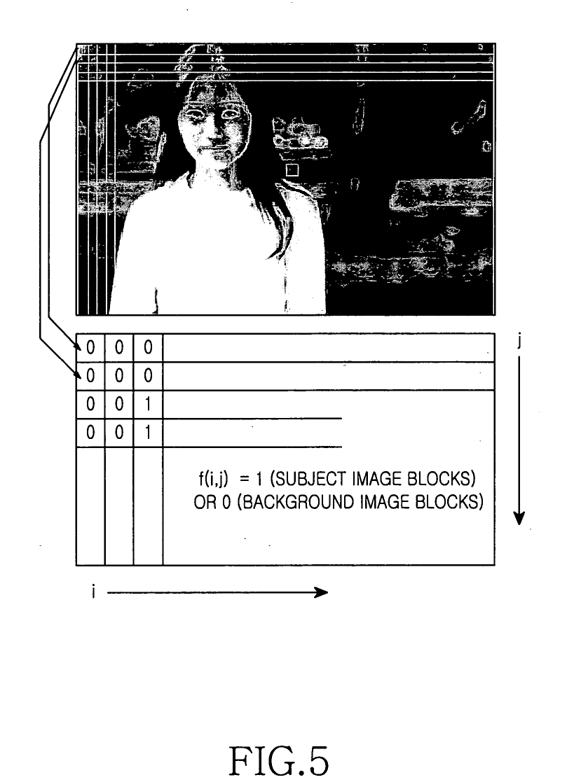

The initial matrix decider 214 determines blocks values for high frequency blocks 403, as illustrated in FIG. 5.

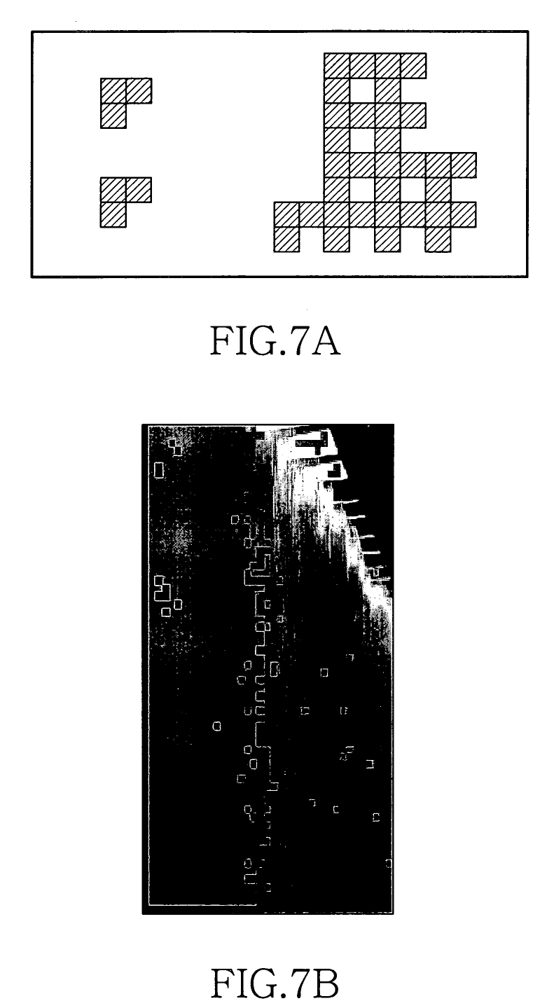

Referring to FIG. 5, an initial block matrix is formed out of the selected blocks, having i rows and j columns. Here, i and j are the numbers of block rows and columns of the images 111 and 112. A matrix value f(i, j) of a block is set to 0 if the subject image 112 is in focus in the block and to 1 if it is not in focus. Only blocks that are 1s are marked in the initial block matrix, as illustrated in FIG. 7A.

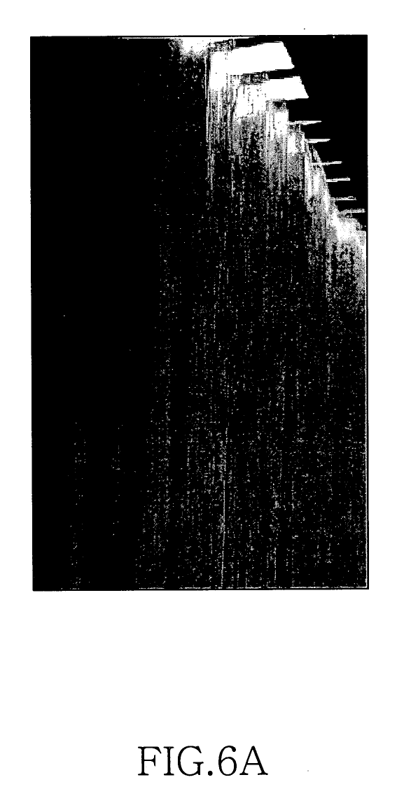

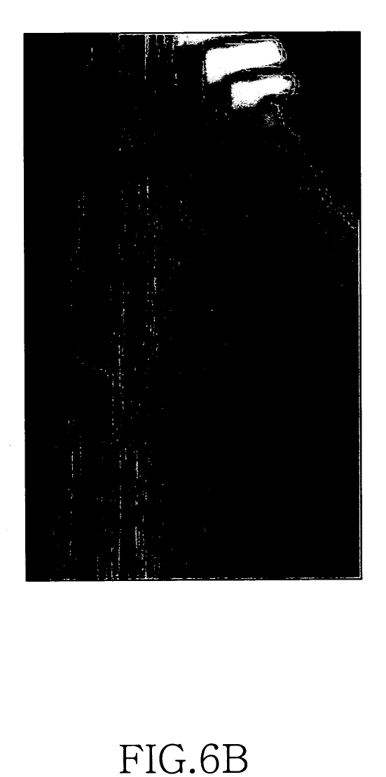

The thus-determined initial block matrix is provided to the filter unit 220. For a description of filtering in the filter unit 220, still images are taken as an example, as illustrated in FIGS. 6A and 6B. After the above-described block matrix processing, an image having only blocks that are 1s as illustrated in FIG. 7B is created from the background and subject images illustrated in FIGS. 6A and 6B.

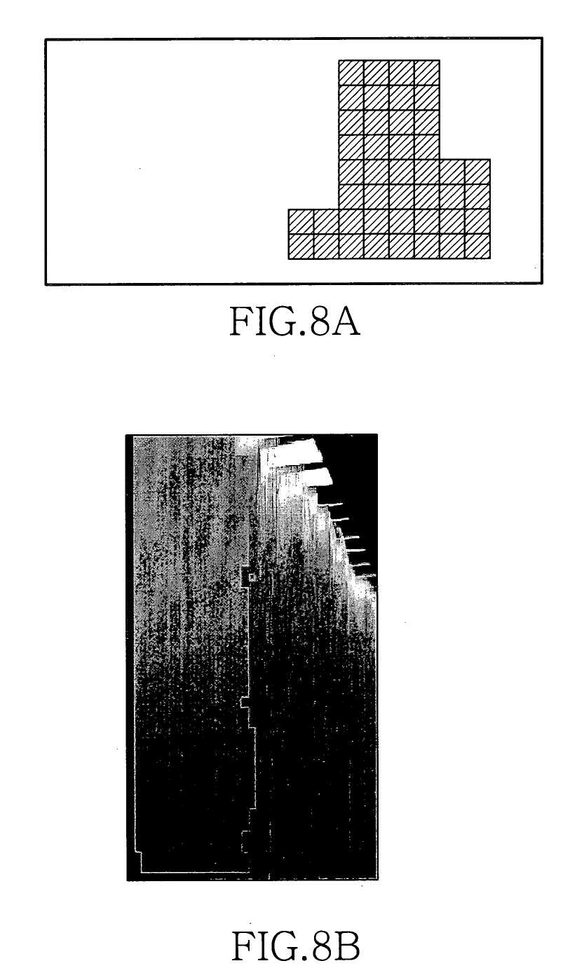

The “1” block set is primarily filtered in the filter 221. If the number of blocks being Is adjacent to a block (i, j) exceeds a predetermined number, for example, 5, the block (i, j) is set to 1 and otherwise, it is set to 0. The resulting blocks and image are illustrated in FIGS. 8A and 8B. This filtering may occur repeatedly, for example, three times. The next filters 222 and 223 operate in the same manner as the filter 221 and output a final block matrix. Thus, the final block matrix represents an image approximate to the nearby subject.

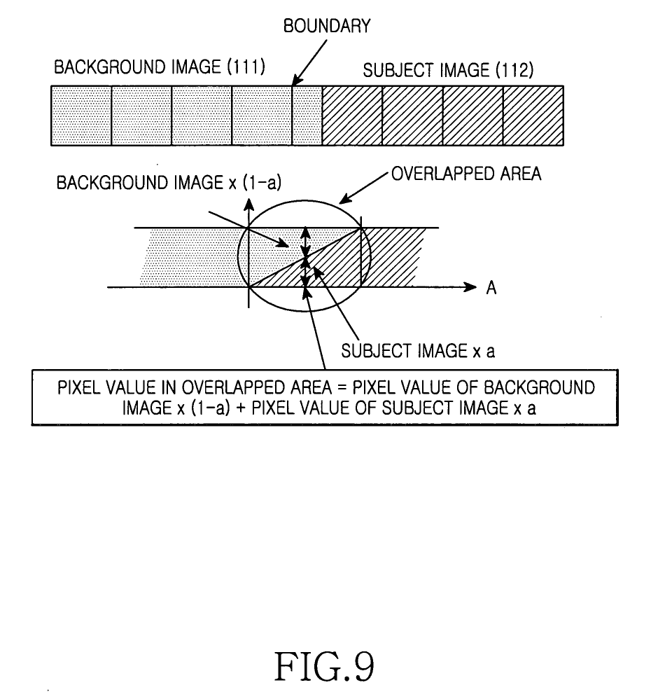

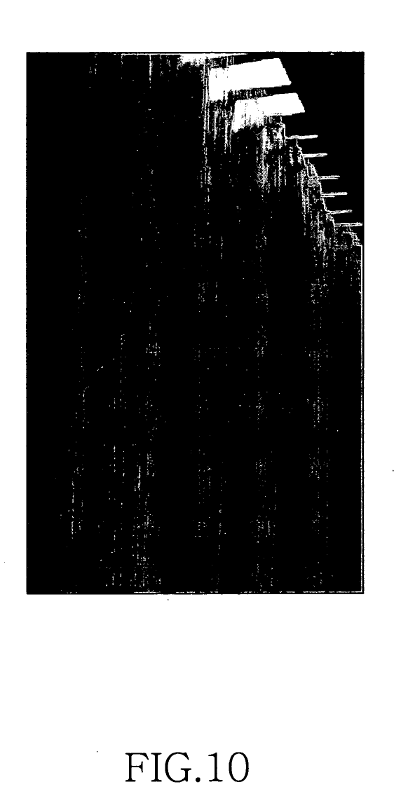

The image combiner 230 stitches the final block matrix into the background image 111. The image stitching results in discontinuity between the background and subject images. To compensate for the discontinuity, the image combiner 230 overlaps the background and subject images, as illustrated in FIG. 9. The images 111 and 112 are overlapped such that an area near to the background image 111 with respect to the boundary has the pixel value of the background image 111. This can be expressed as:
Pixel value in overlapped area=first pixel value×(1−a)+second pixel value×a (1)
where the first pixel value is the pixel value of the background image, the second pixel value is the pixel value of the subject image, and a denotes a proportion of the subject image 112 to the distance between the start and end of the overlap given as 1. By the overlapping, the image combiner 230 produces a final combined image as illustrated in FIG. 10.

While the background image and the subject image are captured simultaneously using a plurality of fixed lenses and then combined in an embodiment of the present invention, it can be further contemplated as another embodiment that the images are captured at different time points using one controllable lens and then combined.

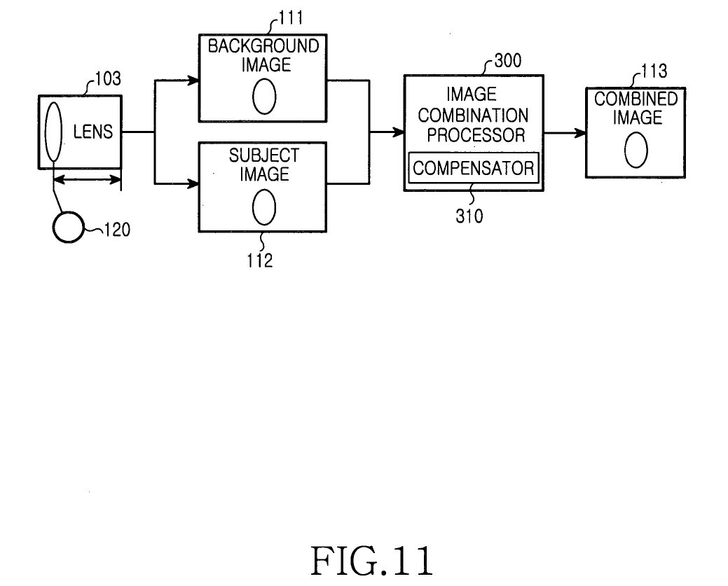

FIG. 11 is a block diagram of an image photographing device in a camera phone according to another embodiment of the present invention.

Referring to FIG. 11, the image photographing device comprises a controllable lens 103 and an image combination processor 300 for combining the background image 111 and the subject image 112 captured at a time interval by the lens 103. To capture images with different focal lengths through the single lens 103, the image photographing device is further provided with a controller 120 for controlling the focal length.

A standard lens is used as the lens 103 to overcome distortion encountered with a wide-angle lens.

The image combination processor 300 is almost identical to the image combination processor 200 illustrated in FIG. 3 in configuration and function.

There is no time difference between the background and subject images 111 and 112 because they are captured simultaneously through a plurality of fixed lenses in the first embodiment of the present invention. In comparison, the single controllable lens 103 captures the two images 111 and 112 at a time interval in the second embodiment of the present invention. Hence, the image combination processor 300 further includes a compensator 310 for compensating for errors caused by the time difference. The image combination processor 300 will be described in more detail.

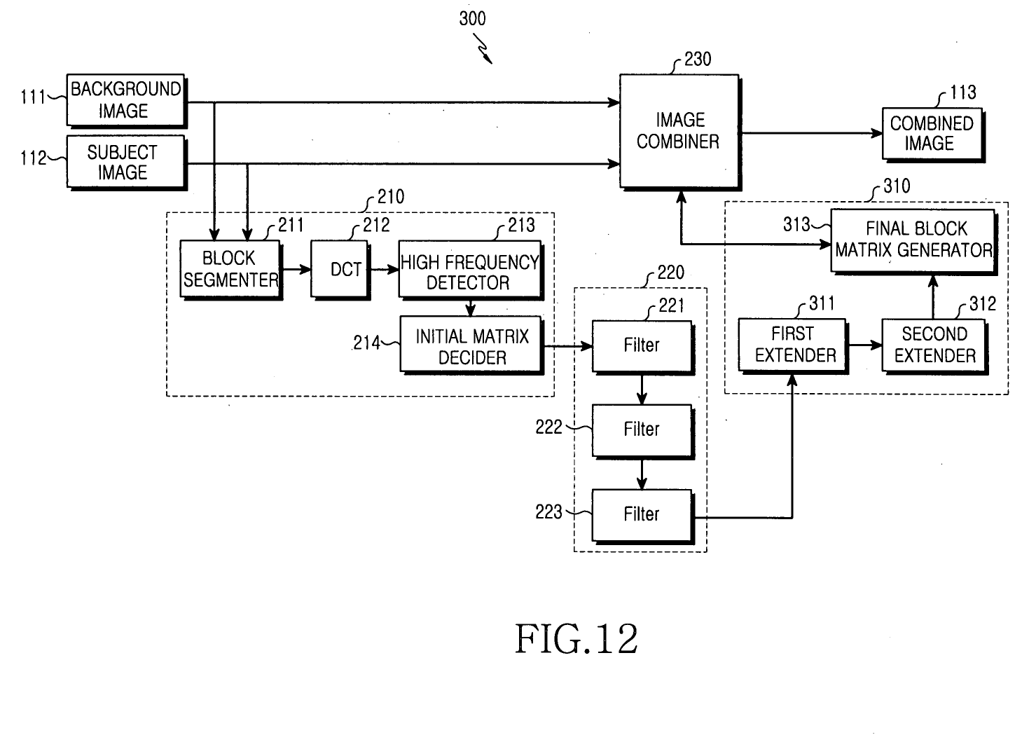

FIG. 12 is a detailed block diagram of the image combination processor according to the second embodiment of the present invention.

Referring to FIG. 12, the image combination processor 300 includes the block matrix unit 210 for detecting high frequency components and generating an initial block matrix, the filter unit 220 for filtering a predetermined block value in the initial block matrix, a compensator 310 for correcting errors by extending filtered blocks, and the image combiner 230 for stitching compensated high frequency blocks, that is, the subject image 112 to the background image 111.

The block matrix unit 210 includes the block segmenter 211 for segmenting the background image 111 and the subject image 112 into blocks, the DCT 212 for representing the blocks in the frequency domain, the high frequency detector 213 for detecting high frequency components from the frequency-domain blocks, and the initial block matrix generator 214 for generating an initial block matrix out of the high frequency components.

The filter unit 220 includes the filters 221, 222 and 223. It filters the initial block matrix in a plurality of steps and outputs a block matrix representing a subject image approximate to the subject in the subject image 112.

The compensator 310 includes a first block extender 311 for compensating for the motion of the subject caused by the time difference between the images by extending the filtered block matrix, a second block extended 312 for curving the corners of the extended blocks, and a final block matrix generator 333 for generating a final block matrix compensated by the second block extender 312 and providing it to the image combiner 230.

The image combiner 230 inserts the final block matrix in a subject area of the background image 111 and overlaps them at their boundaries in order to secure image continuity between them.

A description will now be made of an image photographing method for outputting a totally clear image, that is, a final image by combining two images with different focal lengths captured at different time points.

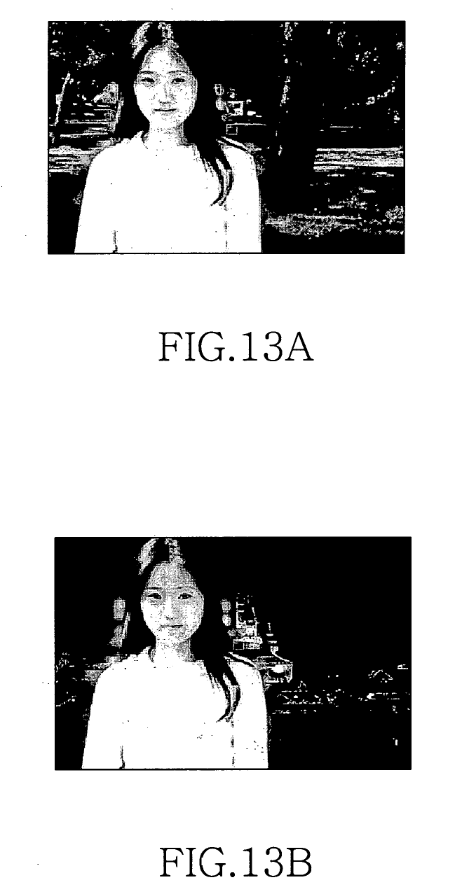

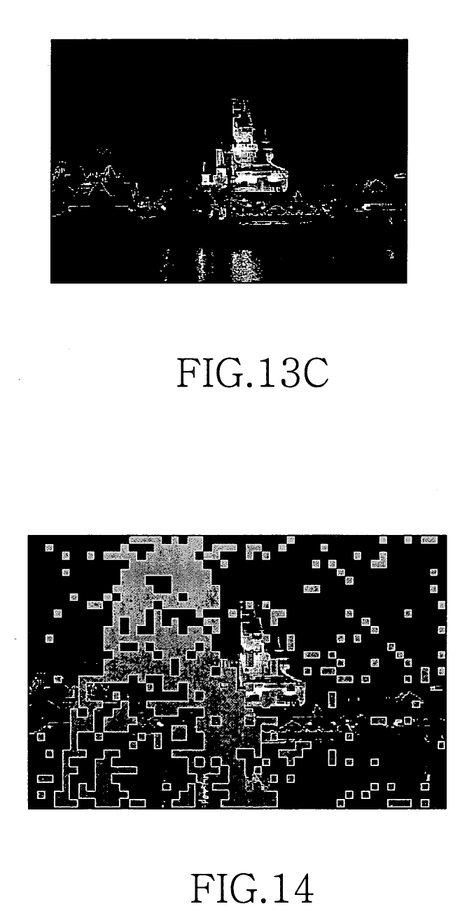

The image photographing device captures the background image 111 with a long distance in focus and the subject image 112 with a short distance in focus through the lens 103 the focal length of which is controllable, as illustrated in FIGS. 13A and 13B.

The background and subject images 111 and 112 are segmented into blocks and DCT-converted in the block matrix unit 210. The DCT is performed in the same manner as in the first embodiment of the present invention and thus its detailed description is not provided here.

DCT blocks 402 are converted to high frequency blocks 403 in the high frequency detector 213. The frequency components of each of them are summed vertically and horizontally and a high frequency block having the most high frequency components is selected as an in-focus block. The DCT 212 can be implemented by using an existing DCT device mounted for video compression without being separately procured. The block values of the high frequency blocks 403 are determined in the initial block matrix decider 214 in the manner described with reference to FIG. 5.

After selecting the high frequency blocks, the initial block matrix is generated by calculating the block values f(i, j) of the blocks. f(i, j) is set to 0 if the subject image 112 is in focus in a block and to 1 if it is not in focus. Only blocks that are 1s are marked in the initial block matrix, as illustrated in FIG. 14.

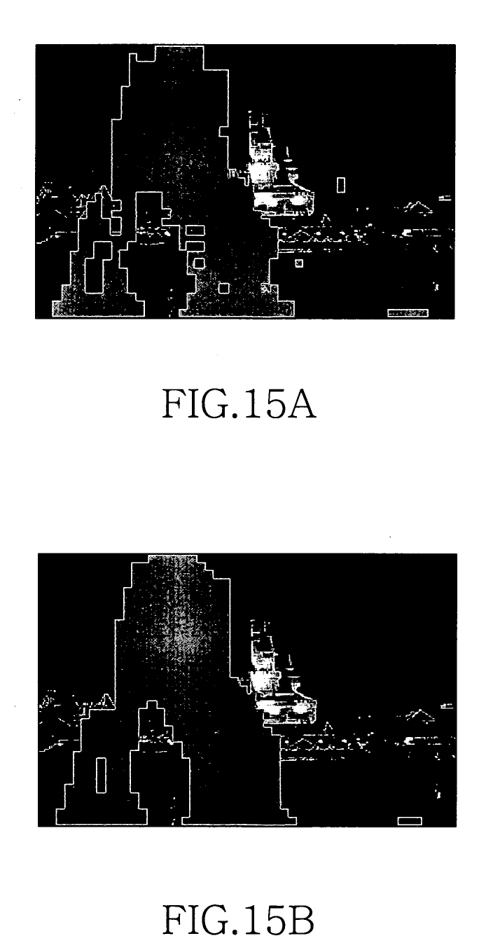

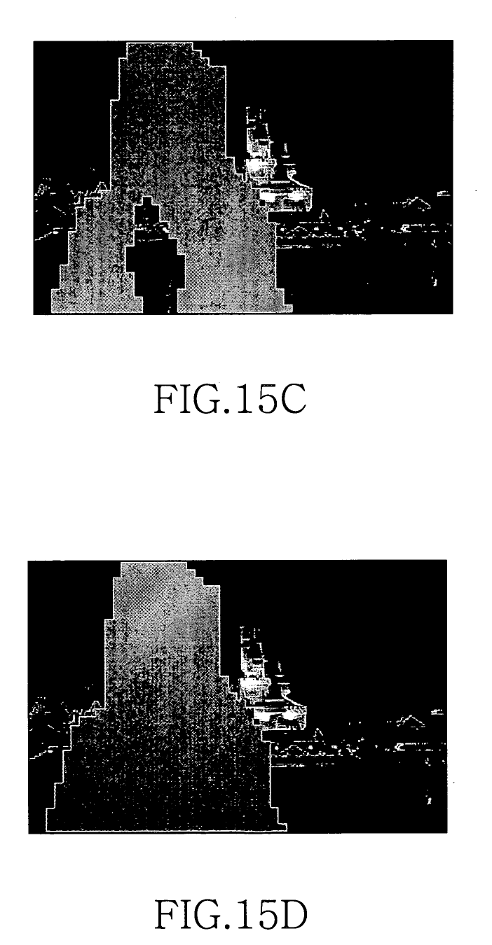

The “1” block set is provided to the filter unit 220. The “1” block set is primarily filtered in the filter 221. If the number of blocks that are 1s adjacent to a block (i, j) exceeds a predetermined number, for example, 5, the block (i, j) is set to 1 and otherwise, it is set to 0. The resulting blocks and image are illustrated in FIGS. 8A and 15A. This filtering may occur repeatedly, for example, three times. The next filters 222 and 223 operate in the same manner as the filter 221 and output a block matrix. Thus, the block matrix represents an image approximate to the nearby subject. The repeated filtering is illustrated in FIGS. 15B, 15C and 15D.

Due to the time difference between the background image 111 and the subject image 112, the positions of the subject are different in the two images when the subject makes a motion. That's why the image photographing device compensates for errors caused by the time difference by use of the compensator 310. The compensation will be described below.

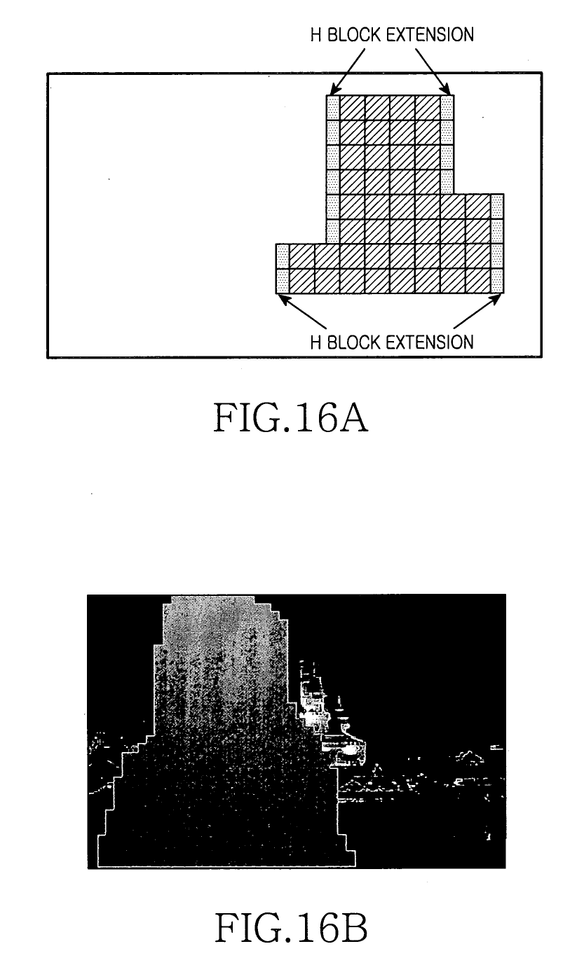

FIG. 16A illustrates extended blocks according to the second embodiment of the present invention.

Referring to FIG. 16A, the first block extender 311 performs an H block extension on the block matrix received from the filter unit 220 so that elements adjacent to blocks that are 1s are set to 1s. The area of the blocks that are 1s, that is, an area sensed as the short-distance subject is expanded to thereby compensate for image errors. The resulting H-extended image is illustrated in FIG. 16B.

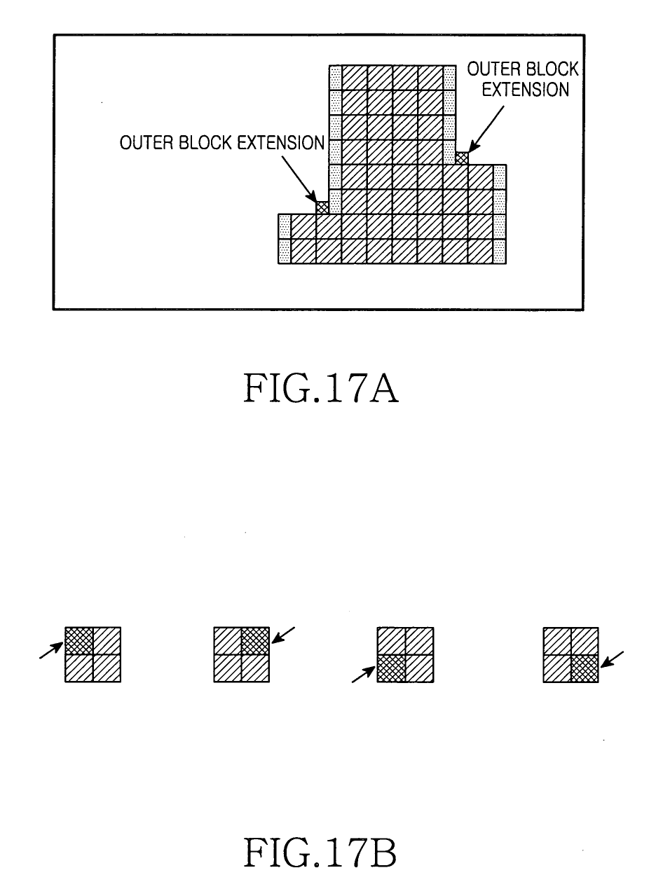

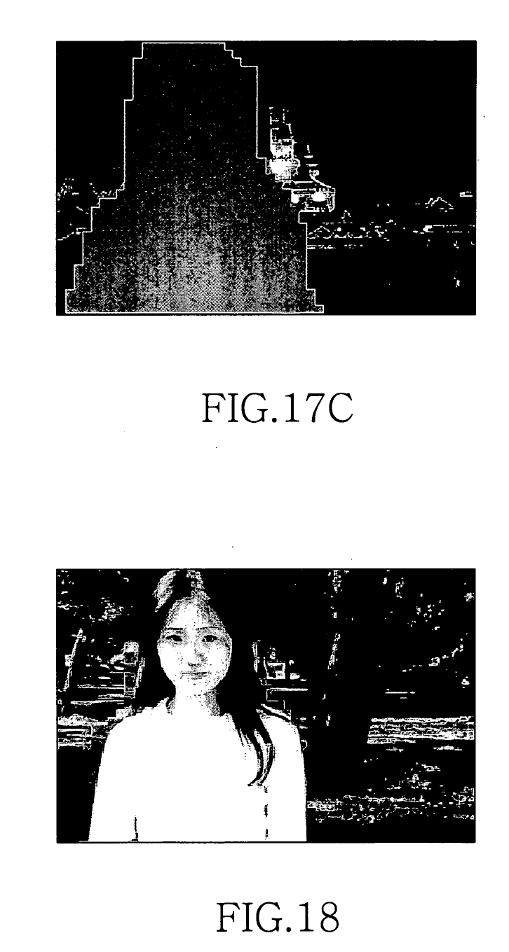

FIGS. 17A and 17B illustrate further extended blocks according to the second embodiment of the present invention.

Referring to FIG. 17A, the H-extended blocks render the corners of the subject to be angular. To make them less sharp, the second block extender 312 sets the corners of the H-extended blocks to 1s. As illustrated in FIG. 16B, if an element is surrounded by at least three “1s” in the block matrix, it is set to 1. Therefore, a set of elements that are 1s in the final compensated block matrix represent a shape approximate to the subject. The final matrix generator 313 outputs the final block matrix to be combined with the background image 111. An image that the final block matrix represents is shown in FIG. 17C.

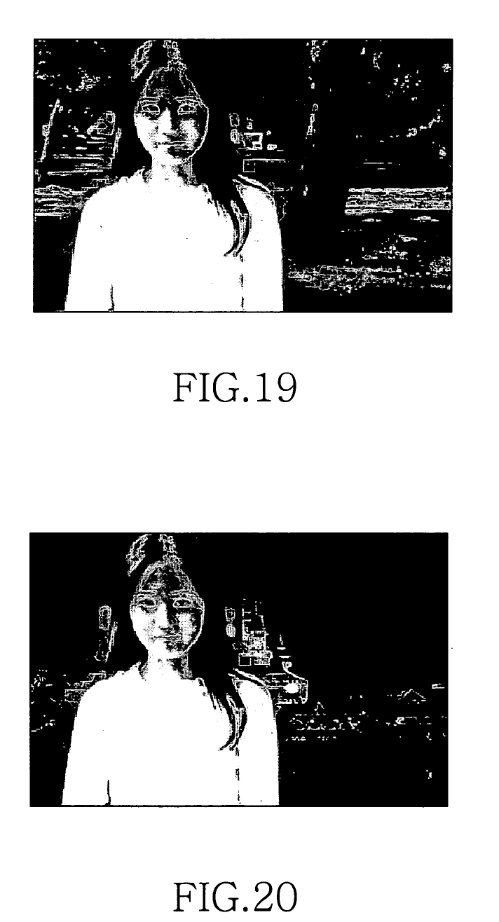

The image combiner 230 stitches the final block matrix into the background image 111, as illustrated in FIG. 18. Referring to FIG. 18, the image stitching results in discontinuity between the background image and the subject image. To compensate for the discontinuity, the image combiner 230 overlaps the background image and the subject image as in the first embodiment of the present invention, as illustrated in FIG. 9. A final combined image after the overlapping is shown in FIG. 19.

While the final combined image is created by stitching a real background image and a real subject image in the above embodiments of the present invention, the final block matrix corresponding to a subject shown in the subject image can be stitched to a stored different background image, as illustrated in FIG. 20.

In the first embodiment of the present invention, images are captured simultaneously using fixed lenses. Thus, there is no time difference between the images, but errors can be generated due to other factors. A compensator is additionally used to compensate for the errors in the second embodiment of the present invention. If a subject makes a very slight motion despite the time difference between the images, the compensation can be omitted.

As described above, the present invention uses an image processing technique of bringing images into accurate focus without distortions. Therefore, a natural, clear picture with all of the scenes front to back and in focus can be captured.

While the invention has been shown and described with reference to certain embodiments thereof, it should be understood by those skilled in the art that various changes in form and details may be made therein without departing from the spirit and scope of the invention as defined by the appended claims.

1. An image photographing device for combining images with different focal lengths to an in-focus image, comprising:
at least one lens for capturing images, for focusing scenes having different distances; and
an image combination processor for segmenting each of the images into a predetermined number of blocks, selecting an in-focus block between every pair of blocks at the same position in the images, and generating a final combined image using the in-focus blocks.

2. The image photographing device of claim 1, wherein the image combination processor comprises:
a block matrix unit for segmenting each of the images into the predetermined number of blocks, converting the blocks to frequency components, detecting high-frequency blocks, and generating an initial block matrix using the high-frequency blocks;
a filter unit for filtering the initial block matrix and outputting a filtered block matrix; and
an image combiner for stitching the filtered block matrix into the image having a long-distance scene in focus and outputting the in-focus final combined image.

3. The image photographing device of claim 2, wherein the filter unit filters the initial block matrix a predetermined number of times.

4. The image photographing device of claim 3, wherein the block matrix unit sums vertical and horizontal high-frequency components of each of the blocks at the same position in the images and selects one of the blocks that has a greater sum as an in-focus block.

5. The image photographing device of claim 3, wherein the block matrix unit comprises:
a block segmenter for segmenting each of the images into the predetermined number of blocks;
a frequency converter for converting the blocks to the frequency components;
a high frequency detector for detecting the high-frequency blocks by comparing blocks at the same position in the images; and
an initial block matrix decider for setting predetermined block values for the detected high-frequency blocks depending on whether the high-frequency blocks are for the short-distance image or the long-distance image, selecting an image having more high-frequency blocks, and forming the initial block matrix using the selected image.

6. The image photographing device of claim 3, further comprising a compensator for extending blocks in the filtered block matrix to compensate for image distortion.

7. The image photographing device of claim 6, wherein the compensator comprises:
a first block extender for generating an extended block matrix by setting blocks adjacent to the filtered block matrix to the block value of the filtered block matrix; and
a second block extender for setting blocks adjacent to corners of the extended block matrix to the block value of the filtered block matrix to render the corners to be less sharp.

8. The image photographing device of claim 1, further comprising a controller for controlling a focal length to capture the images with different focal lengths at a time interval, when the number of the at least one lens is one.

9. An image photographing method for combining images with different focal lengths to an in-focus image, comprising the steps of:
capturing the images with different focal lengths simultaneously; and
segmenting each of the images into a predetermined number of blocks;
marking in-focus blocks in the images; and
combining images represented by the in-focus blocks into a final combined image.

10. The image photographing method of claim 9, wherein the in-focus block marking step comprises the steps of:
converting the blocks to frequency components, detecting high-frequency blocks, and generating an initial block matrix using the high-frequency blocks; and
outputting the final block matrix corresponding to an image represented by the in-focus blocks by filtering the initial block matrix a predetermined number of times.

11. The image photographing method of claim 10, wherein the initial block matrix generating step comprises the steps of:
converting the blocks to the frequency components;
detecting the high-frequency blocks by comparing blocks at the same position in the images; and
generating the initial block matrix by setting the detected high-frequency blocks to predetermined block values depending on whether the high frequency blocks are for an image with a short distance in focus or an image with a long focus distance.

12. The image photographing method of claim 11, wherein the high-frequency block detecting step comprises the step of calculating the sum of vertical and horizontal high-frequency components of each of the blocks at the same position in the images and selecting one of the blocks that has a greater sum as an in-focus block.

13. The image photographing method of claim 9, wherein the final combined image outputting step comprises the step of stitching the image represented by the in-focus blocks into a predetermined area of the image having a long focus distance.

14. The image photographing method of claim 9, further comprising the step of extending the image having the in-focus blocks, thereby compensating for image distortion.

15. The image photographing method of claim 14, wherein the compensation step comprises the steps of:
generating an extended block matrix by setting blocks adjacent to the filtered block matrix to the block value of the filtered block matrix; and
setting blocks adjacent to corners of the extended block matrix to the block value of the filtered block matrix to render the corners to be less sharp.

16. An image photographing method for combining images with different focal lengths to an in-focus image, comprising the steps of:
capturing the images with different focal lengths at different time points; and
segmenting each of the images into a predetermined number of blocks;
marking in-focus blocks in the images; and
combining images represented by the in-focus blocks into a final combined image.

17. The image photographing method of claim 16, wherein the in-focus block marking step comprises the steps of:
converting the blocks to frequency components, detecting high-frequency blocks, and generating an initial block matrix using the high-frequency blocks; and
outputting a final block matrix corresponding to an image having the in-focus blocks by filtering the initial block matrix a predetermined number of times.

18. The image photographing method of claim 17, wherein the initial block matrix generating step comprises the steps of:
converting the blocks to the frequency components;
detecting the high-frequency blocks by comparing blocks at the same position in the images; and
generating the initial block matrix by setting the detected high-frequency blocks to predetermined block values depending on whether the high frequency blocks are for an image with a short distance in focus or an image with a long-distance in focus.

19. The image photographing method of claim 18, wherein the high-frequency block detecting step comprises the step of calculating the sum of vertical and horizontal high-frequency components of each of the blocks at the same position in the images and selecting one of the blocks that has a greater sum as an in-focus block.

20. The image photographing method of claim 16, wherein the final combined image outputting step comprises the step of stitching the image corresponding to the in-focus blocks into a predetermined area of the image having a long distance in focus.

21. The image photographing method of claim 16, further comprising the step of extending the image represented by the in-focus blocks, thereby compensating for image distortion.

22. The image photographing method of claim 21, wherein the compensation step comprises the steps of:
generating an extended block matrix by setting blocks adjacent to the filtered block matrix to the block value of the filtered block matrix; and
setting blocks adjacent to corners of the extended block matrix to the block value of the filtered block matrix to render the corners to be less sharp.
